(19) United States
(12) Patent Application Publication
(10) Pub. No.: US 2008/0035822 A1
(43) Pub. Date: Feb. 14, 2008

(54) Folding table leg

(75) Inventor: Chao-Ken Chen, Chung Hua Hsien (TW)

Correspondence Address: NATH & ASSOCIATES, PLLC, 112 South West Street, Alexandria, VA, 22314, US

(73) Assignee: MOORECO. LP., Temple, TX (US)

(21) Appl. No.: 11/501,029

(22) Filed: Aug. 9, 2006

(51) Int. Cl. F16M 11/32; A47B 91/00

(52) U.S. Cl. 248/439; 248/188.8

(57) ABSTRACT

Disclosed is a table leg system including a leg, an anchor pivotally supporting the leg, and a locking sleeve slidingly engaged with the leg. The locking sleeve is at least partially encircled by at least a single ridge. An embodiment of the table leg system includes a leg, an anchor pivotally supporting the leg, and a locking sleeve slidingly engaged with the leg. The locking sleeve is at least partially encircled by a single groove. Another embodiment of the table leg system includes a table engagement anchor, a locking cylinder integrally extending from a planar surface of the table engagement anchor, and a leg extending from the table locking cylinder. The leg is repositionable between an extended position and a folded position. Yet additional embodiments of the table leg system include a table leg, an anchor plate comprised of a planar surface, and a neck extending perpendicularly from the planar surface of said anchor plate. The neck includes a recess, and at least one retaining projection extending into the recess integrally configured in a surface of the neck. Yet a further table leg system includes an anchor plate having a planar surface, a neck that extends perpendicularly from the planar surface of the anchor plate; a plurality of outwardly protruding reinforcing ribs around an intersection of the neck with the planar surface of the anchor plate.

### FIELD OF THE INVENTION

The present invention is for a folding table leg system including a locking mechanism for securing an articulating leg in one of multiple configurations.

### BACKGROUND

Folding tables are widely used and derive their primary benefit from the relative ease with which they can be handled and stored when in the folded condition. When in the folded condition, the table minimizes the space needed for storage. Tables with foldable legs are commonly used in homes, offices, training rooms, cafeterias, etc. when extra table space is needed. When not needed, the tables are folded up and stored in some convenient manner.

To minimize the amount of space needed for storage, it is desirable to fold the legs flat against the table top, thereby minimizing the overall thickness of the space occupied by the table top and the legs. In many conventional folding tables, each folding leg includes a pivot connection near or at the end of the leg attached to the table.

Typically, folding tables include some type of mechanism to prevent the legs from collapsing when they are in the extended position, i.e., when the legs extend from the table top. Many locking mechanisms are often difficult to operate or do not effectively retain the legs in their extended position. Regardless, it is also desirable that the legs lie flat against the table top when they are in the folded position to facilitate stacking and storage. Previous table legs have been designed where an upper pivot rod passes through the vertical table leg and is pivotally connected to an outer pair of side portions that define an outer edge of a top plate; and a pair of brace links have been pivotally connected to the table leg and are secured to an inner pair of side portions mounted inwardly from the outer edge of the top plate. Also in previous designs, a pair of release brackets has been connected to the inner pair of side portions to retain the table leg in its extended position. In these previous designs, to reconfigure the table leg from an extended position to a folded position, each of the pair of the release brackets must be separately depressed in order to allow the table leg to return to its folded position. Therefore, to release the table leg from the extended position in order to move it to the folded position, the user must depress both of the release brackets simultaneously, thus requiring the use of two hands.

Also, the prior art reveals a number of additional structures that are designed to enable a working surface, for example, a table, to be moved from its working position to its stored condition. However, previous foldable table legs have been unstable and awkward.

### SUMMARY OF THE INVENTIVE ASPECTS

Disclosed is a table leg system, a first embodiment of which includes a leg, an anchor pivotally supporting the leg, and a locking sleeve slidingly engaged with the leg. The locking sleeve partially encircled by at least a single ridge. Variations of this embodiment can be configured such that the leg is in communication with a table via the anchor.

Embodiments of the table leg system can include an anchor engaging pin that defines an axis of rotation of the leg. The locking sleeve in various embodiments can be biased toward the anchor by a spring. The locking sleeve can include a plurality of ridges on a surface thereof, which can completely encircle the locking sleeve.

Other embodiments of the table leg system can include a leg, an anchor pivotally supporting the leg, and a locking sleeve slidingly engaged with the leg. The locking sleeve can be at least partially encircled by a single groove and biased toward the anchor by a spring, or the locking sleeve can be completely encircled by a plurality of grooves. The leg of the table leg system can be configured such that the leg is in communication with a table via the anchor. The leg can include an anchor engaging pin that defines an axis of rotation of the leg.

Further embodiments of the table leg system can include a table engagement anchor, a locking cylinder that integrally extends from a planar surface of the table engagement anchor, and a leg that extends from the table locking cylinder. The leg can be repositionable between an extended position and a folded position. Features of further embodiments of the table leg system can include a locking sleeve that slidingly encircles the leg and that is engageable with the locking cylinder sleeve when the leg is in an extended position. The locking cylinder can have at least one groove and can be biased toward the table engagement anchor. Further features of the table leg system can include an anchor engaging pin that defines an axis of rotation of the leg and the ability of the leg to be telescoping.

Yet further embodiments of the table leg system can include a table leg, an anchor plate having a planar surface, a neck extending perpendicularly from the planar surface of the anchor plate and including a recess, and at least one retaining projection extending into the recess such that the retaining projection is integrally configured in a surface of the neck. The shape of the retaining projection should conform to the shape of the neck. The table leg can be pivotable and repositionable between an extended position and a retracted position and can include a locking sleeve that at least partially encircles the table leg. The retaining projection can be engageable with the locking sleeve when the pivotable leg is in a retracted position. The locking sleeve can have at least one groove thereon and can be biased toward the neck. The pivotable leg can be telescoping and can include a neck engaging pin that defines an axis of rotation of the pivotable leg.

Yet another embodiment of the table leg system can include an anchor plate having a planar surface, a neck extending perpendicularly from the planar surface of the anchor plate, and a leg surrounded by and extending from the neck. The leg can be telescoping and hingedly connected to the neck and can be repositionable between a first and a second position. The first and second positions can be an extended position and a retracted position. And a plurality of outwardly protruding reinforcing ribs surrounds an intersection of the neck with the planar surface of the anchor plate. Features of the table leg system include a locking cylinder that integrally extends from said neck and a locking sleeve that partially encircles the leg. The locking cylinder is engageable with the locking sleeve when the leg is in the extended position.

### DESCRIPTION OF THE DRAWINGS

FIG. 1a shows an embodiment of a foldable table leg attached to a table top and in an extended configuration;

FIG. 1b shows an embodiment of a foldable table leg attached to a table top and in a folded configuration;

FIG. 2a shows an embodiment of the inventive foldable table leg in an extended configuration with a locking sleeve engaged with a locking collar;

FIG. 2b shows the embodiment of FIG. 2a of the inventive foldable table leg having a portion of the surface of the locking sleeve removed to show a spring;

FIG. 3 shows an embodiment of the inventive foldable table leg in an extended configuration with a locking sleeve unengaged with the locking collar;

FIG. 4 shows an embodiment of the inventive foldable table leg in a folded configuration with the locking sleeve unengaged with a retaining projection;

FIG. 5 shows an embodiment of the inventive foldable table leg in a folded configuration with the locking sleeve engaged with the retaining projection;

FIG. 6 shows a detailed view of an embodiment of a lower sliding leg portion and an upper encompassing leg portion of the inventive foldable table leg;

FIG. 7a shows a side view of an additional embodiment of the inventive foldable table leg;

FIG. 7b shows a back view of the additional embodiment of the inventive foldable table leg as shown in FIG. 7a; and

FIG. 8 shows a variation of the additional embodiment of the inventive foldable table leg shown in FIG. 7a.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

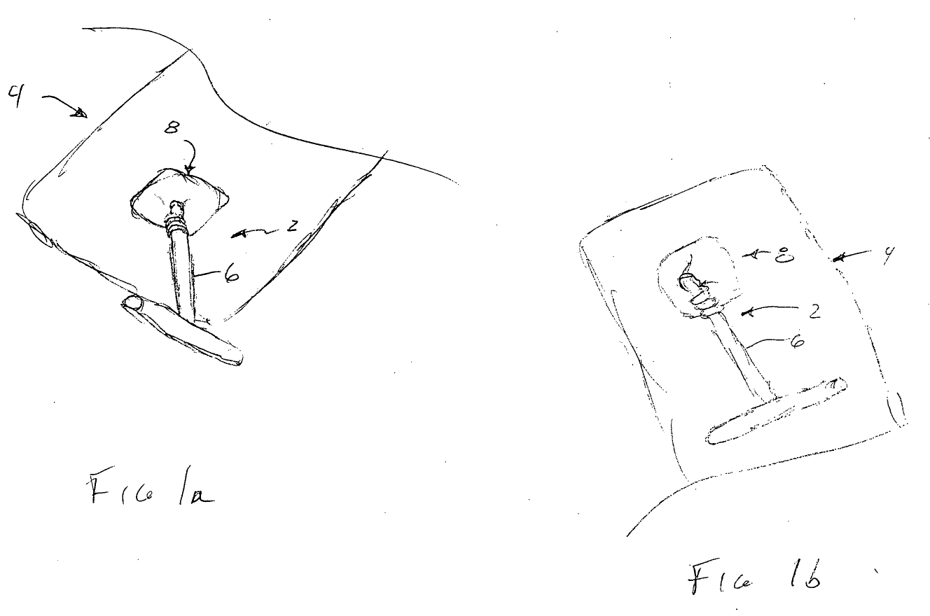

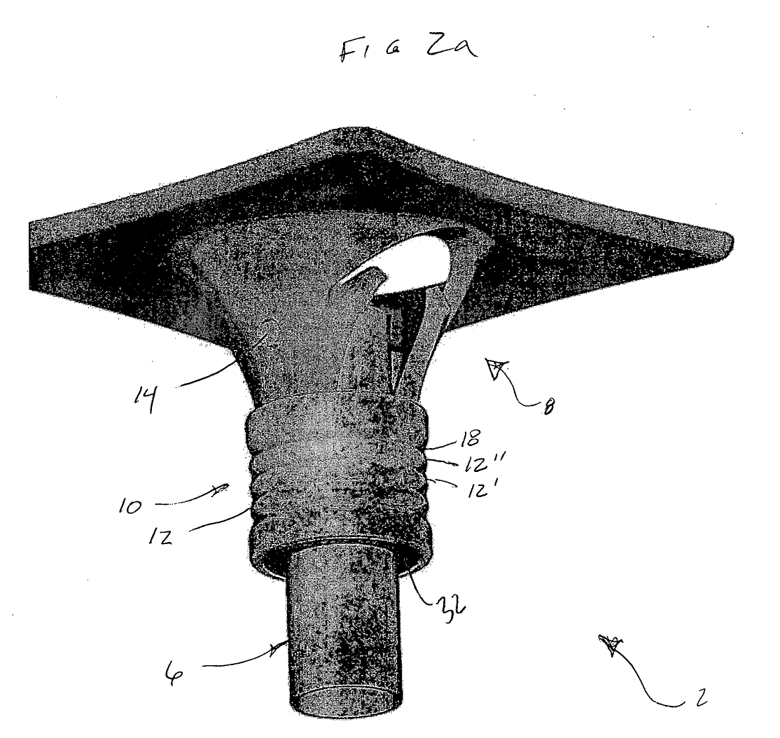

FIG. 1a shows an embodiment of the inventive folding table leg 2 attached in an extended position to an underside of a table top 4; and FIG. 1b shows the folding table leg 2 in a folded position. The “extended” and “folded” positions of the folding table leg 2 are not limited to the configurations depicted in the various embodiments shown in the multiple figures present herein; rather, the folding table leg 2 can be in any position relative to the table top 4 to enhance its use as a leg supporting a table top or, alternatively, to enable its ability to be repositioned for easier compact storage.

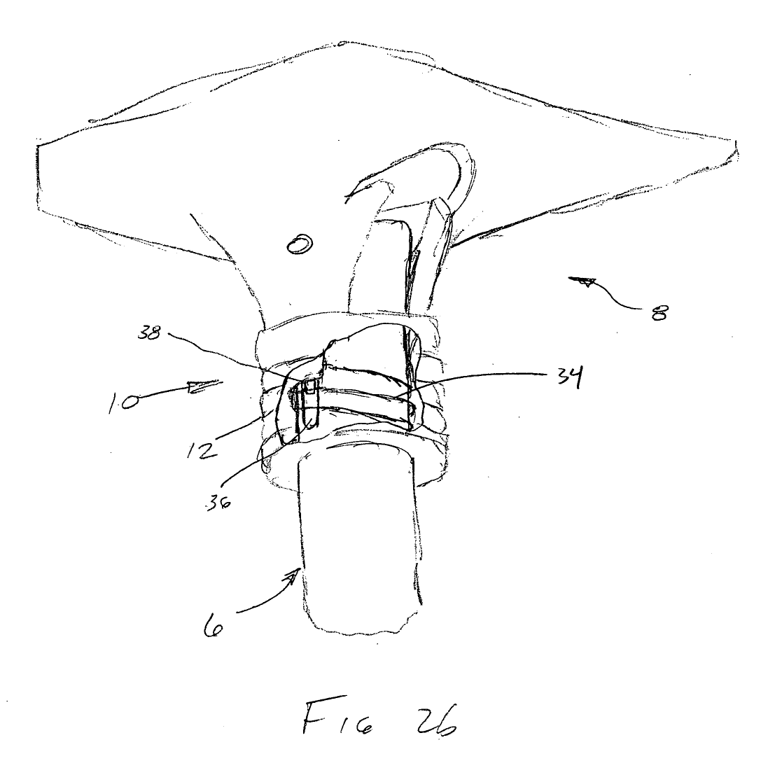

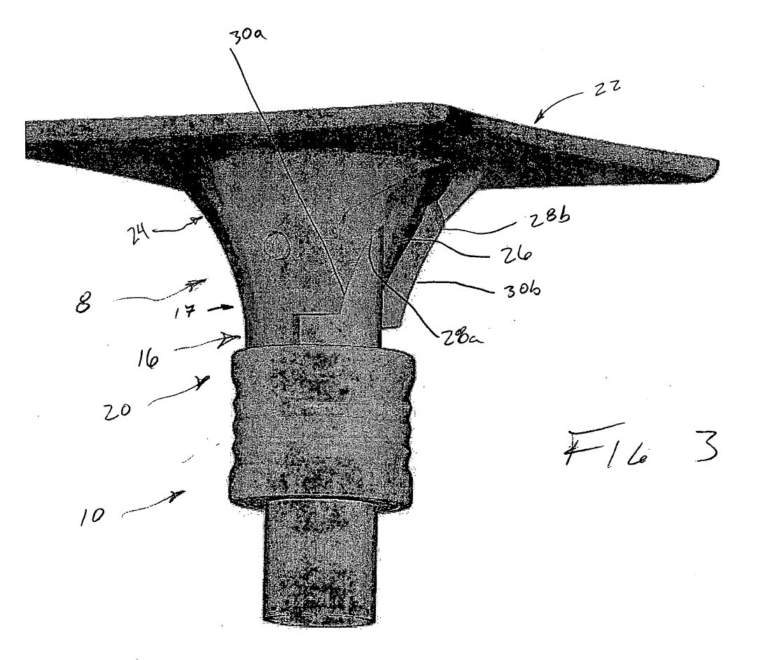

FIG. 2a shows a more detailed view the end of folding table leg 2 that communicates with the table top 4. Folding table leg 2 includes a leg 6, an anchor 8 pivotally supporting the leg 6, and a locking sleeve 10 slidingly engaged with the leg 6. The locking sleeve 10 is at least partially encircled by at least a single ridge 12. The locking sleeve 10 does not have to completely encircle the leg 6; also, the locking sleeve can be of any length such that it can be easily grasped by a person.

An anchor engaging pin 14 is positioned in the anchor 8 and defines an axis of rotation of the leg 6. Anchor engaging pin 14 helps keep the leg 6 and the anchor 8 in communication with each other. The locking sleeve 10 is biased toward the anchor 8 by a spring 34 shown in FIG. 2b. A slide pin 38 of the locking sleeve 10 is slidingly engaged with a track 36 in the leg 6. Engagement of the slide pin 38 with the track 36 prevents the locking sleeve 10 from becoming remotely disengaged from the anchor 8. The locking sleeve 10 includes a relief 32 on each of its ends. As explained in more detail below, the relief 32 is allows for engagement with a locking collar and a retaining projection. For easier gripping, the locking sleeve 10 includes on its surface at least a single ridge 12 or a plurality of ridges 12′ and 12″. The ridges 12, 12′ and 12″ at least partially encircle the locking sleeve 10 but can also completely encircle the locking sleeve 10. Alternatively, the locking sleeve can include a single groove 18 or a plurality of grooves.

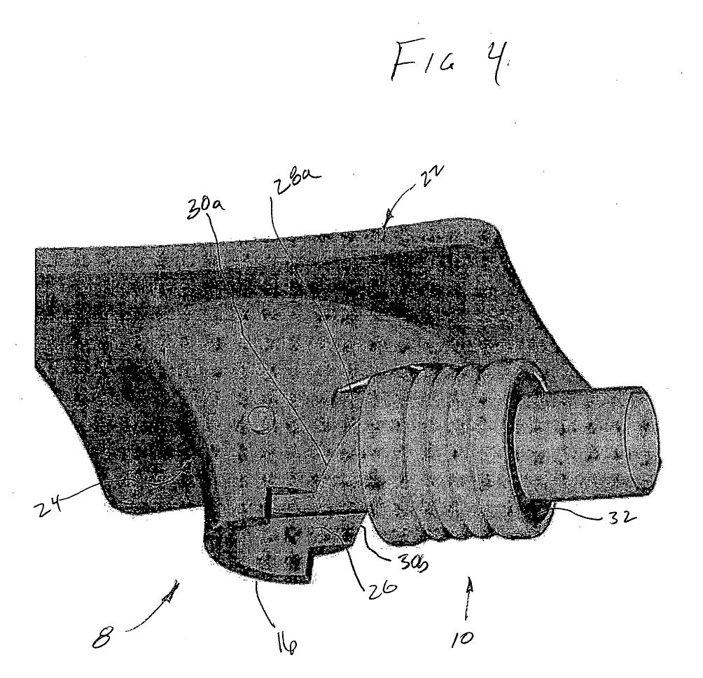

As shown in FIG. 3, the anchor 8 includes a locking collar 16 at a stem end 17 of the anchor 8. As can be seen from FIG. 3, it is not necessary that the locking collar 16 extend completely along the stem end 17. The locking collar 16 should at least be extensive enough to engage with an engaging end 20 of the locking sleeve 10. When the leg 6 is in an extended position, the engaging end 20 of the locking sleeve 10 fits around the locking collar 16 so that the locking collar 16 keeps the leg 6 locked in an extended position. The locking sleeve 10 engaged with the locking collar 16 also keeps the leg 6 in a firm position so that the table does not wobble as a result of the leg 6 being loosely connected to the anchor 8.

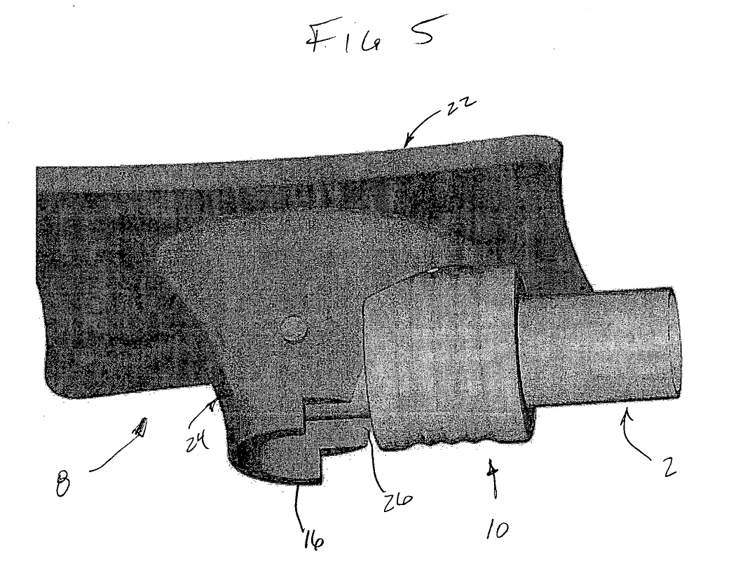

To reconfigure the leg 6 from an extended position to a folded position, a person grasps the locking sleeve 10 and pulls the locking sleeve 10 away from the anchor 8 to disengage the locking sleeve 10 from the locking collar 16 and, in particular, to disengage the engaging end 20 of the locking sleeve 10. (FIG. 3 shows the locking sleeve 10 pulled away from the locking collar 16.) The leg 6 is then free to rotate about the anchor engaging pin 14 from the extended position as shown in FIG. 3 to a folded position as shown in FIG. 4. As is explained hereinafter, the foldable table leg 2 is locked into its folded configuration when the locking sleeve 10 engages a retaining projection.

As mentioned above, the foldable table leg 2 is attachable to a table top 4. The anchor 8 of the foldable table leg 2 is fixed to a table top 4 through one or a combination of various means. Non-limiting examples of means for affixing the foldable table leg 2 to the table top 4 include adhesives, threaded fasteners, screws, clamps, pins, magnets, or any other device or substance capable of securing to surfaces together.

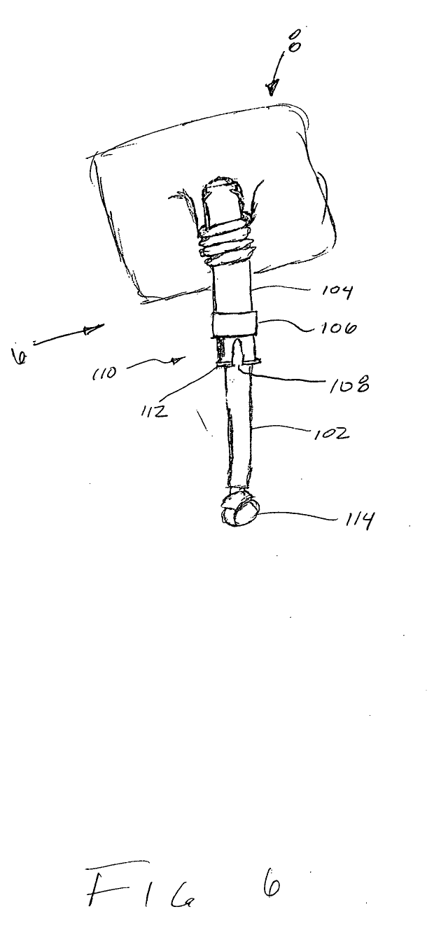

With further respect to FIGS. 3-5, various embodiments of the table leg system include a table leg, an anchor plate 22 having a planar surface, and a neck 24. The neck 24 includes a recess 26 that extends perpendicularly from the planar surface of the anchor plate 22. At least one retaining projection 28a extends into the recess 26 such that the retaining projection 28a is integrally configured in a surface of the neck. A second retaining projection 28b can be included in this embodiment. The shape of the retaining projections 28a and 28b should conform to the shape of the neck 24. That way, manufacturing processes for the anchor 8 are made less complex due to the simpler structure of the anchor 8. When the foldable table leg 2 is in a folded configuration, the retaining projection 28a is engageable with the locking sleeve 10. As mentioned above, to reconfigure the foldable table leg 2 from an extended configuration, a person disengages the locking sleeve 10 from the locking collar 16. During reconfiguration of the foldable table leg 2 from an extended position to a folded position, a person can either maintain the locking sleeve 10 in a retracted position or a person can release the locking sleeve 10 and let the locking sleeve 10 slide along recess guide rails 30a and 30b until the locking sleeve 10 reaches the retaining projection 28a. Once the foldable table leg 2 reaches a fully folded configuration, the locking sleeve 10 will engage the retaining projection 28a in a similar manner as the locking collar 16. The neck recess 26 is configured to provide enough relief for the locking sleeve 10 to fully engage the retaining projection 28a as shown in FIG. 5.

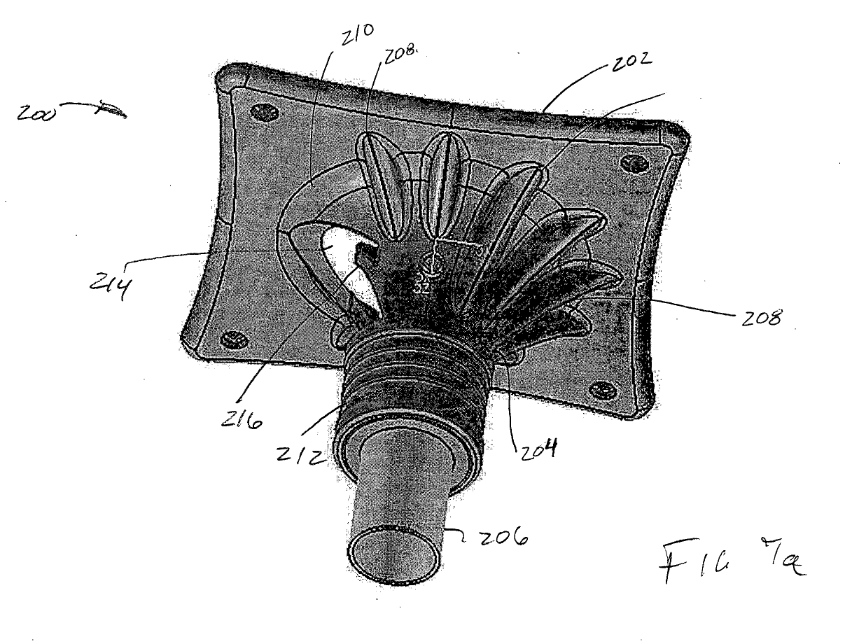

In an embodiment shown with greater particularity in FIG. 6, the leg 6 is telescoping so that if the leg 2 is removably attached to a table with, for example, magnets, reattachable adhesives, etc, the foldable table leg 2 can be placed on a different table that requires a leg of a different height than the table on which the foldable table leg 2 was originally positioned. For example, a person desiring to use the table leg system 2 on coffee table can shorten the leg 6 to a proper height, or if a person desires to use the legs on an end table or a card table, the leg 6 can be extended to a proper length. The telescoping feature of the folding table leg system works by having at least one sliding lower leg portion 102 positioned within an upper encompassing leg portion 104. The upper encompassing leg portion 104 is attached to the anchor 8 while the sliding lower leg portion 102 is extendible within the upper encompassing leg portion 104. The sliding lower leg portion 102 can be locked in a position by any of various means, including non-limiting examples such as a clamp, a screw, a clip, a magnet or any other means, shown generally in FIG. 6 as 106. The locking means 106 is capable of providing pressure from the upper encompassing leg portion 104 to the sliding lower leg portion 102 such that the sliding lower leg portion is prevented from telescopic movement within the upper encompassing leg portion 104. Also, the upper encompassing leg portion 104 includes a relief 108 to allow the circumference of the lower end 110 of the upper encompassing leg portion 104 to reduce and firmly engage the sliding lower leg portion 102. Further, the upper encompassing leg portion 104 can include a flange 112 at the lower end 110 of the upper encompassing leg portion so that the locking means 106 does not become dislodged from the upper encompassing leg portion 104. The flange 112 can also serve as the foot of the leg 6 in the event that a person wishes to remove the sliding lower leg portion 102 and rest a table on the leg 2 using only the upper encompassing leg portion 104. Further, for mobility within a room while the leg 6 is in an extended position, a caster 114 can be attached to the end of the sliding lower leg portion 102 (or to the end of the upper encompassing leg portion 104) so that a table can be repositioned within an area without having to reconfigure the leg 6 from an extended position to a folded position.

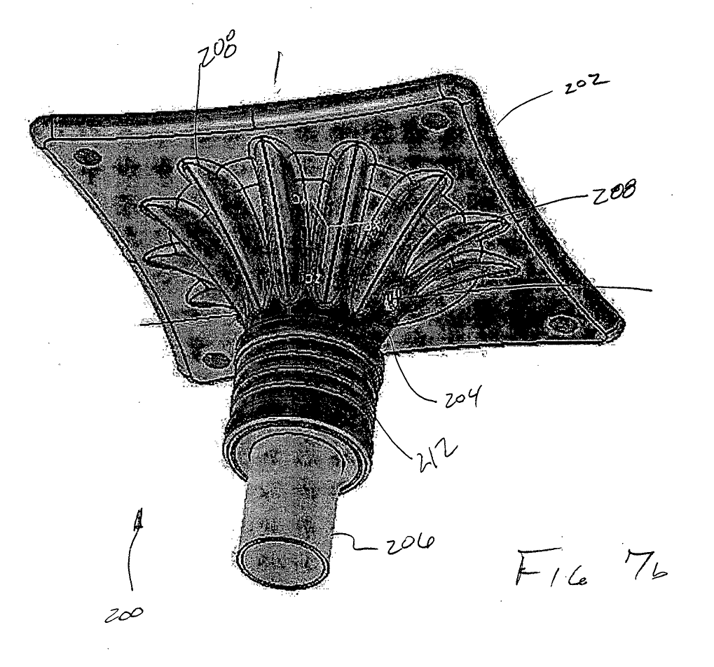

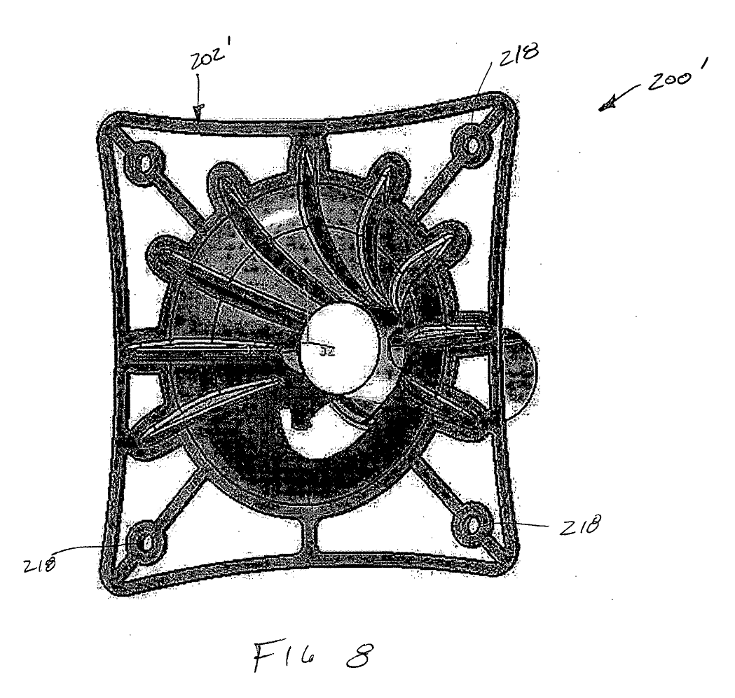

An additional embodiment of the table leg system is depicted in FIGS. 7a and 7b as 200 and, similar to the earlier described embodiments, includes an anchor plate 202 having a planar surface, a neck 204 extending perpendicularly from the planar surface of the anchor plate 202, and a leg 206 surrounded by and extending from the neck 204. To provide additional strength to prevent deformation of the anchor neck 204, a plurality of outwardly protruding reinforcing ribs 208 surrounds an intersection 210 of the neck 204 with the planar surface of the anchor plate 202. As discussed above, the table leg system includes a locking sleeve 212 that partially encircles the leg 206. This embodiment also includes a recess 214 with at least one retaining projection 216 extending into the recess 214.

A variation of the embodiment shown in FIGS. 7a and 7b of the inventive foldable table leg is shown in FIG. 8 as 200′. The foldable table leg 200′ has material removed from the anchor plate 202 to form webbed anchor plate 202′. Although the webbed anchor plate 202′ can be attached to a table top in any manner possible, the depiction of the foldable table leg 200′ shown in FIG. 8 includes screw holes 218. The omission of material from the anchor plate 202 to produce anchor plate 202′ has the advantage of reducing material costs associated with manufacturing the foldable table leg as well as making the table leg lighter for shipping or lifting.

The previous description of embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. For example, one or more elements can be rearranged and/or combined, or additional elements may be added. Thus, the present invention is not intended to be limited to the embodiments shown herein, but is to be accorded the widest scope consistent with the principles and novel features disclosed herein and claimed in the following appended claims.

I claim:

1. A table leg system comprising:
a leg;
an anchor pivotally supporting said leg;
a locking sleeve slidingly engaged with said leg; and
said locking sleeve having at least a single ridge at least partially encircling said locking sleeve.

2. A table leg system as recited in claim 1 wherein said leg is in communication with a table via said anchor.

3. A table leg system as recited in claim 2 wherein said leg includes an anchor engaging pin defining an axis of rotation of said leg.

4. A table leg system as recited in claim 1 wherein said locking sleeve is biased toward said anchor by a spring.

5. A table leg system as recited in claim 1 wherein said locking sleeve is further comprised of a plurality of ridges.

6. A table leg system as recited in claim 5 wherein said plurality of ridges completely encircle said locking sleeve.

7. A table leg system comprising:
a leg;
an anchor pivotally supporting said leg;
a locking sleeve slidingly engaged with said leg; and
said locking sleeve having at least a single groove at least partially encircling said locking sleeve.

8. A table leg system as recited in claim 7 wherein said leg is in communication with a table via said anchor.

9. A table leg system as recited in claim 8 wherein said leg includes an anchor engaging pin defining an axis of rotation of said leg.

10. A table leg system as recited in claim 7 wherein said locking sleeve is biased toward said anchor by a spring.

11. A table leg system as recited in claim 7 wherein said locking sleeve is further comprised of a plurality of grooves.

12. A table leg system as recited in claim 11 wherein said plurality of grooves completely encircle said locking sleeve.

13. A table leg system comprising
a table engagement anchor;
a locking cylinder integrally extending from a planar surface of said table engagement anchor; and
a leg extending from said table locking cylinder, said leg repositionable between an extended position and a folded position.

14. A table leg system as recited in claim 13 further comprised of a locking sleeve slidingly encircling said leg.

15. A table leg system as recited in claim 14 wherein said locking sleeve is engageable with said locking cylinder sleeve when said leg is in an extended position.

16. A table leg system as recited in claim 15 wherein said locking sleeve comprises at least one groove.

17. A table leg system as recited in claim 15 wherein said locking sleeve is biased toward said table engagement anchor.

18. A table leg system as recited in claim 15 wherein said leg includes an anchor engaging pin defining an axis of rotation of said leg.

19. A table leg system as recited in claim 13 wherein said leg is telescoping.

20. A table leg system comprising
a table leg;
an anchor plate comprised of a planar surface;
a neck extending perpendicularly from said planar surface of said anchor plate, said neck including a recess; and
at least one retaining projection extending into said recess integrally configured in a surface of said neck.

21. A table leg system as recited in claim 20 wherein said table leg is pivotable and repositionable between an extended position and a retracted position.

22. A table leg system as recited in claim 21 further comprised of a locking sleeve at least partially encircling said table leg.

23. A table leg system as recited in claim 22 wherein said at least one retaining projection is engageable with said locking sleeve when said pivotable leg is in a retracted position.

24. A table leg system as recited in claim 23 wherein said locking sleeve comprises at least one groove.

25. A table leg system as recited in claim 23 wherein said locking sleeve is biased toward said neck.

26. A table leg system as recited in claim 23 wherein said pivotable leg includes a neck engaging pin defining an axis of rotation of said pivotable leg.

27. A table leg system as recited in claim 21 wherein said table leg is telescoping.

28. A table leg system as recited in claim 20 wherein a shape of said retaining projection conforms to the shape of said neck.

29. A table leg system comprising
an anchor plate comprised of a planar surface;
a neck extending perpendicularly from said planar surface of said anchor plate;
a leg surrounded by and extending from said neck, said leg being repositionable between a first and a second position; and
a plurality of outwardly protruding reinforcing ribs around an intersection of said neck with said planar surface of said anchor plate.

30. A table leg system as recited in claim 29 further comprising a locking cylinder integrally extending from said neck.

31. A table leg system as recited in claim 30 further wherein said leg is hingedly connected to said neck.

32. A table leg system as recited in claim 31 further comprised of a locking sleeve partially encircling said leg.

33. A table leg system as recited in claim 32 wherein said leg is pivotable between an extended position and a retracted position.

34. A table leg system as recited in claim 33 wherein said locking cylinder is engageable with said locking sleeve when said leg is in said extended position.

35. A table leg as recited in claim 34 wherein said locking sleeve is biased toward said neck.

36. A table leg system as recited in claim 34 wherein said leg is telescoping.
